(19) United States
(12) Patent Application Publication
(10) Pub. No.: US 2013/0164482 A1
(43) Pub. Date: Jun. 27, 2013

(54) Decorative and Protective Covering

(71) Applicant: Anthony Tornetta, Pottstown, PA (US)

(72) Inventor: Anthony Tornetta, Pottstown, PA (US)

(21) Appl. No.: 13/652,261

(22) Filed: Oct. 15, 2012

Related U.S. Application Data
(60) Provisional application No. 61/547,173, filed on Oct. 14, 2011.

(51) Int. Cl. B32B 3/02; B32B 5/02; B32B 27/00; B32B 3/26; B32B 25/00

(52) U.S. Cl. CPC B32B 3/02; B32B 3/266; B32B 25/00; B32B 27/00; B32B 5/02
USPC 428/68

(57) ABSTRACT

The present invention generally relates to covering for a window sill, a fireplace mantel or ledge. The covering can be used for the purpose of decoration. The covering can be used for the purpose of protection. The covering can be used for the purpose of energy savings. The present invention relates to a covering comprising a core material, enclosed by a cover having a first portion which encloses the core and a second portion which extends downward from first portion.

### CROSS-REFERENCE TO RELATED APPLICATIONS

This application claims priority to U.S. Provisional Application No. 61/547,173 filed Oct. 14, 2011, which is hereby incorporated by reference.

### FIELD OF THE INVENTION

The present invention relates to a decorative and protective covering for a window sill, a fireplace mantel or other ledge.

### SUMMARY OF THE INVENTION

The present invention generally relates to a covering for a window sill, a fireplace mantel or other ledge that provides decoration, protection and energy savings.

The present invention relates to a covering for a window sill, fireplace mantel or ledge comprising a cover which spans a portion or the entire length of a window sill, fireplace mantel or ledge.

The present invention relates to a covering comprising a cover which spans a portion or the entire length of a window sill, fireplace mantel or ledge into which a core material can be placed.

The present invention relates to a covering comprising a core material enclosed by a cover for protecting or decorating the window sill, fireplace mantel or ledge.

The present invention also relates to a covering comprising a core material enclosed by a cover, wherein the cover and the core contain an opening for insertion of a candle.

The present invention also relates to a covering comprising a cover, wherein the cover contains an opening for insertion of a candle.

The present invention also relates to a covering comprising a cover, wherein the cover contains an opening for insertion of a candle.

The present invention relates to a covering comprising a core of cushion or cushions, enclosed by a cover.

The present invention relates to a window sill seat covering comprising a core of a cushion or cushions, enclosed by a cover.

The present invention relates to a covering comprising a core of cushion or cushions, enclosed by a cover for use as a seat for pets.

### BRIEF DESCRIPTION OF THE DRAWINGS

FIG. 1 depicts a covering for a window sill according to the present invention.

FIG. 2 depicts a front view of a covering for a window sill according to the present invention.

FIG. 3 depicts an enlarged view of a covering and core material according to the present invention.

FIG. 4 depicts a side view of a covering and core material according to the present invention.

FIG. 5 depicts an enlarged view of a covering and core material with an insert for a candle according to the present invention.

### DETAILED DESCRIPTION OF THE INVENTION

The present invention generally relates to covering for a window sill, a fireplace mantel or ledge. The covering can be used for the purpose of decoration. The covering can be used for the purpose of protection. The covering can be used for the purpose of energy savings.

In one embodiment, the present invention relates to a covering having a first portion and a second portion which extends from the first portion. In one embodiment, the present invention relates to a covering having a first portion and a second portion which extends downward from the first portion. In another embodiment, the first portion and second portion of the covering are continuous with one another.

In some embodiments, a core material can be placed into the covering. In another embodiment, the present invention relates to a window sill, fireplace mantel or ledge covering comprising a core material enclosed by a cover. In one embodiment, the present invention relates to a covering comprising a core material, enclosed by a cover having a first portion which encloses the core material and a second portion which extends from first portion. In one embodiment, the present invention relates to a covering comprising a core material, enclosed by a cover having a first portion which encloses the core material and a second portion which extends downward from first portion. In some embodiments, the first portion and the second portion of the cover are continuous.

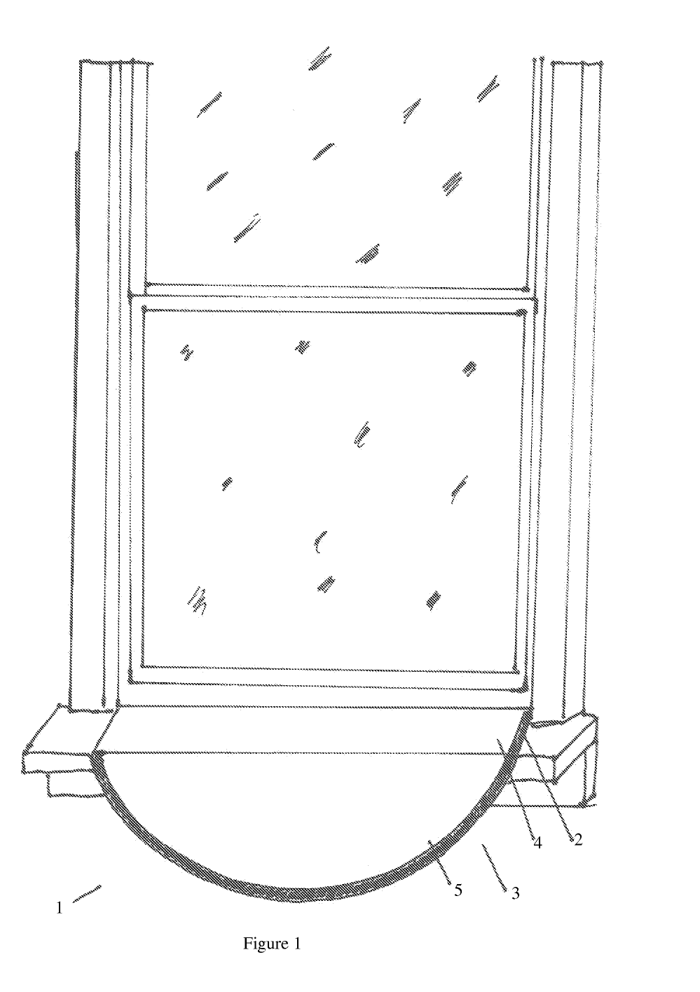

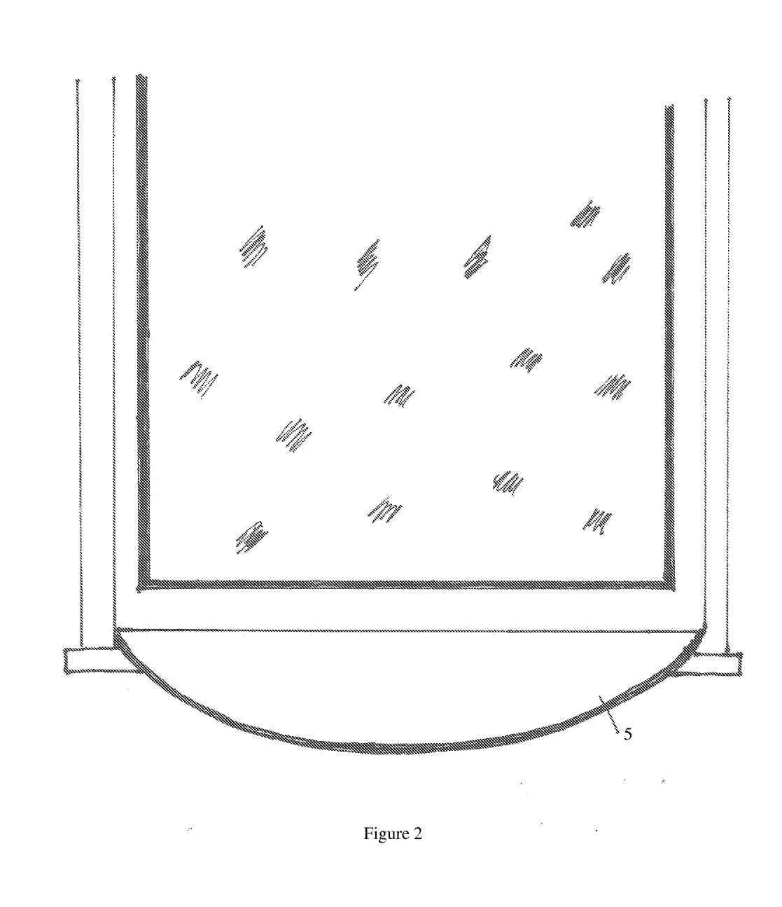

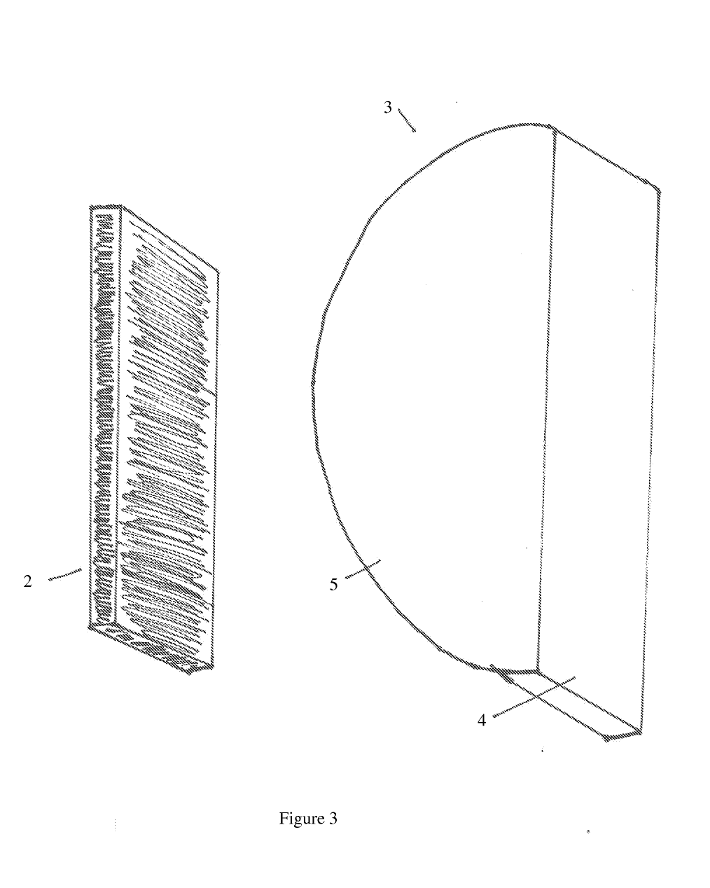

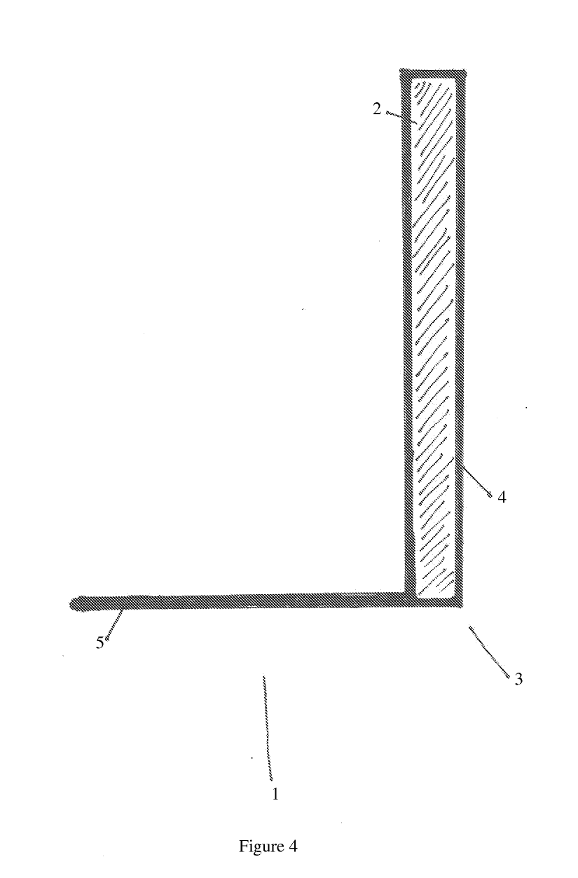

In one embodiment, as shown in FIG. 1, the present invention relates to a window sill covering 1 comprising a core material 2, enclosed by a cover 3 having a first portion 4 which encloses the core material 2 and a second portion 5 which extends downward from first portion 4. FIG. 2 depicts a front view of a window sill covering 1 of the present invention, in which the second portion 5 of cover 3 is visible. FIG. 3 depicts an enlarged view of the cover 3 having a first portion 4 and a second portion 5, and the core material 2. FIG. 4 depicts a side view of window sill covering 1 comprising a core material 2, enclosed by a cover 3 having a first portion 4 which encloses the core material 2 and a second portion 5 which extends downward from first portion 4.

In one embodiment, the present invention relates to a covering for a window sill, fireplace mantel or ledge which spans a portion of the window sill, fireplace mantel or ledge. In one embodiment, the present invention relates to a covering for a window sill, fireplace mantel or ledge which spans the entire length of the window sill, fireplace mantel or ledge. In one embodiment, the present invention relates to a covering for a window sill, fireplace mantel or ledge which spans a portion of the window sill, fireplace mantel or ledge into which a core material can be placed. In one embodiment, the present invention relates to a covering for a window sill, fireplace mantel or ledge which spans the entire length of the window sill, fireplace mantel or ledge into which a core material can be placed.

In one embodiment, the present invention relates to a window sill, fireplace mantel or ledge covering comprising a cover having a first portion which rests on the sill, mantel or ledge and a second portion which extends downward from the first portion.

In one embodiment, the present invention relates to a window sill, fireplace mantel or ledge covering comprising a core material, enclosed by a cover having a first portion which encloses the core material and a second portion which extends downward from the first portion.

In one embodiment, the present invention relates to a window sill, fireplace mantel or ledge covering comprising a core material and a cover having a first portion which encloses the core material and a second portion which extends downward from the first portion.

In one embodiment, the window sill comprises a window seat. In one embodiment, the present invention relates to a window seat covering comprising a cover which encloses cushions. In one embodiment, the present invention relates to a window seat covering comprising a cover having a first portion which encloses a cushion or cushions, and a second portion which extends downward from first portion. In another embodiment, the present invention relates to a window seat covering comprising a core material and a cover having a first portion which encloses the core material and a second portion which extends downward from first portion. In another embodiment, the present invention relates to a window seat covering comprising a core material and a cover having a first portion which encloses the core material and a second portion which extends downward from first portion, wherein the core comprises a cushion. In another embodiment, the present invention relates to a window seat covering comprising a core and a cover having a first portion which encloses the core and a second portion which extends downward from first portion, wherein the core material comprises cushions.

In one embodiment, the present invention relates to a window sill covering comprising a core material of cushion or cushions, enclosed by a cover for use as a seat for pets.

In one embodiment of the present invention, the covering rests on the window sill, fireplace mantel or ledge. In another embodiment, the covering is attached to the window sill, fireplace mantel or ledge. In another embodiment, the covering is attached to the window sill, fireplace mantel or ledge with a fastener. The fastener can be any fastener which can attach the covering to the window sill, fireplace mantel or ledge. The fastener can be any fastener which one of skill in the art can envision. In some embodiments, the fastener includes but is not limited to tape, Velcro, nails, screws, glue, tacks, and staples. In another embodiment, the fastener is a track, into which the covering is inserted into. In one embodiment, the track is attached to the window sill, mantel or ledge. In other embodiments, the fastener comprises a spring-loaded bar or a retractable bar.

### Core Material

In one embodiment, the core material comprises a rigid material. In another embodiment, the core material comprises a flexible material. In one embodiment, the core material comprises a lightweight material. In one embodiment, the core material comprises a heavyweight material. In one embodiment, the core material comprises a one-piece body of material. In one embodiment, the core material comprises a plurality of bodies of material. In one embodiment, the core material comprises a one-piece body of a lightweight material. In one embodiment, the core material comprises a one-piece body of a lightweight, relatively rigid material. In one embodiment, the core material comprises a one-piece body of a heavyweight material. In another embodiment, the core material comprises a plurality of bodies of a lightweight material. In another embodiment, the core material comprises a plurality of bodies of a heavyweight material. In one embodiment, the core material comprises a one-piece body of a flexible material. In one embodiment, the core material comprises one-piece body of a rigid material. In another embodiment, the core material comprises a plurality of bodies of flexible material. In another embodiment, the core material comprises a plurality of bodies of rigid material.

In one embodiment, the core material comprises a weighted material. In one embodiment, the core material comprises rubber. In another embodiment, the core material comprises sand. In one embodiment, the core material comprises plastic. In another embodiment, the core material comprises foam. In another embodiment, the core material comprises metal. In another embodiment, the core material comprises cork. In another embodiment, the core material comprises split peas. In one embodiment, the core material comprises a spring-loaded bar or rod. In another embodiment, the core material comprises a retractable bar or rod. In one embodiment, the core material comprises wood. In another embodiment, the core material comprises a cushion. In another embodiment, the core material comprises cushions. The core material can comprise any material which one of skill in the art can envision.

In one embodiment, the core material comprises an elongated material.

In one embodiment, the core material extends the entire length of the window sill, fireplace mantel or ledge. In one embodiment, the core material extends a portion of the length of the window sill, fireplace mantel or ledge.

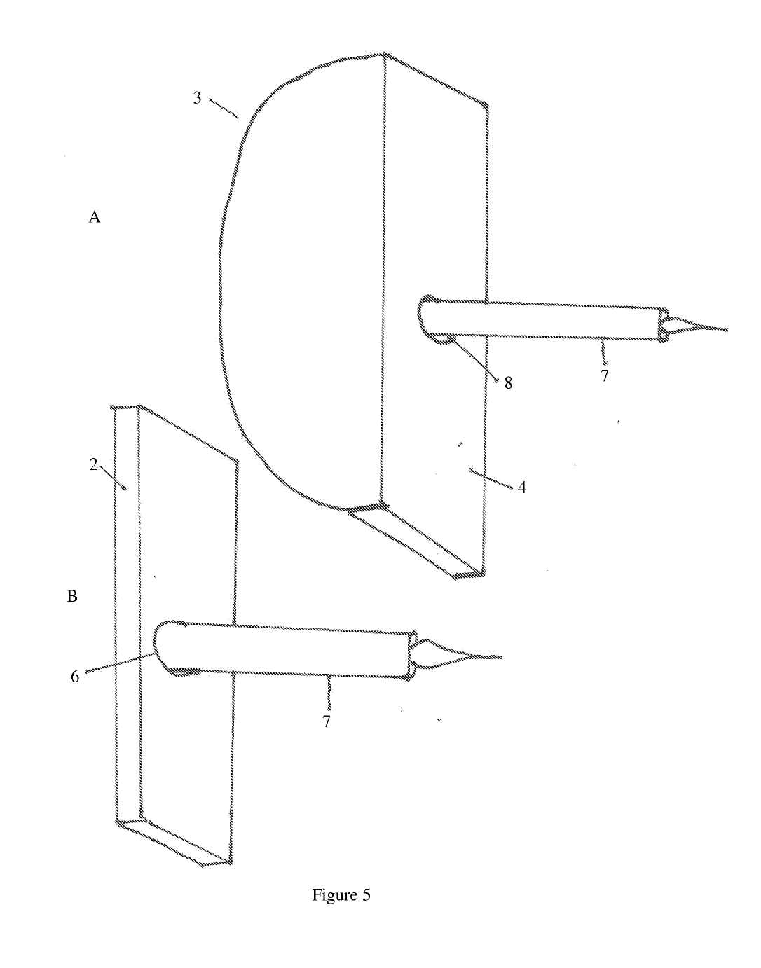

In another embodiment, as shown in FIG. 5B, the core material contains an opening. In one embodiment, the core material contains an opening at the middle of the core material. In one embodiment, as shown in FIG. 5, the core material 2 contains an opening 6 at the middle of the core material to allow for insertion of a candle 7.

### Cover

In one embodiment, the cover comprises a fabric. In one embodiment, the fabric comprises cotton. In another embodiment, the fabric comprises wool. In another embodiment, the fabric comprises flannel. In another embodiment, the fabric comprises polyester. In another embodiment, the fabric comprises fleece. In another embodiment, the fabric comprises silk. In another embodiment, the fabric comprises denim. In another embodiment, the fabric comprises leather. In another embodiment, the fabric comprises plastic. In one embodiment, the fabric comprises rubber. The fabric can be any fabric which one of skill in the art can envision.

In one embodiment, the cover is removable from core material.

In one embodiment, the cover comprises a first portion which encloses a core material and a second portion which extends downward from the first portion. In one embodiment, the cover comprises a first portion which encloses a core material and a second portion which extends downward from the first portion, wherein the first portion rests on top of a window sill, fireplace mantel or ledge.

In one embodiment, the cover fits closely around core material.

In one embodiment, the cover encloses a core material with a closure mechanism. In one embodiment, the closure mechanism comprises a zipper. In one embodiment, the closure mechanism comprises a snap. In one embodiment, the closure mechanism comprises Velcro. In one embodiment, the closure mechanism comprises buttons. In one embodiment, the closure mechanism is stitches.

In one embodiment, the cover extends the entire length of the window sill, fireplace mantel or ledge. In one embodiment, the cover extends a portion of the length of the window sill, fireplace mantel or ledge.

In another embodiment, the cover contains an opening. In one embodiment, the cover contains an opening in the middle of the cover. In one embodiment, the cover contains an opening in the middle of the cover to allow for insertion of a candle. In one embodiment, as shown in FIG. 5, the cover 3 contains an opening 8 in the middle of the first portion 4 of cover 3 to allow for insertion of a candle 7.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the invention.

I claim:

1. A covering comprising a core material, enclosed by a cover having a first portion which encloses the core material and a second portion which extends from first portion.

2. The covering of claim 1, wherein the core material comprises rubber.

3. The covering of claim 1, wherein the core material comprises plastic.

4. The covering of claim 1, wherein the cover comprises fabric.

5. The covering of claim 1, wherein the cover is removable.

6. The covering of claim 1, wherein the second portion extends downward from first portion.

7. The covering of claim 1, wherein the cover contains an opening.

8. The covering of claim 1, wherein the core material contains an opening.

9. The covering of claim 1, wherein the cover contains an opening and the core material contains an opening.

10. A covering comprising a first portion and a second portion which extends downward from first portion.
